(19) United States
(12) Patent Application Publication
(10) Pub. No.: US 2024/0412649 A1
(43) Pub. Date: Dec. 12, 2024

(54) METHOD AND FLIGHT DATA ANALYZER FOR IDENTIFYING ANOMALOUS FLIGHT DATA AND METHOD OF MAINTAINING AN AIRCRAFT

(71) Applicant: UNIVERSITY OF MALTA, Msida (MT)

(72) Inventors: Robert CAMILLERI, Msida (MT); Gianluca VALENTINO, Msida (MT); Alan MUSCAT, Mosta (MT); Sameer Kumar JASRA, Msida (MT)

(73) Assignee: UNIVERSITY OF MALTA, Msida (MT)

(21) Appl. No.: 18/698,294

(22) PCT Filed: Oct. 4, 2022
(86) PCT No.: PCT/EP2022/077542

§ 371 Date: Apr. 3, 2024

(30) Foreign Application Priority Data
Oct. 4, 2021 (GB) 2114174.2

(51) Int. Cl. G08G 5/00

(52) U.S. Cl. CPC G08G 5/0047

(57) ABSTRACT

A computer implemented method of identifying anomalous flight data is provided. The method comprises: receiving a plurality of flight data units in a time series from each of a plurality of different flights, wherein each flight data unit comprises a value for each of a plurality of flight parameters at the same time point; mapping the flight data units as respective data points to a multi-dimensional space, wherein the dimensions of the multi-dimensional space comprise a dimension for each of the plurality of flight parameters; and identifying one or more anomalous flight data units in the received plurality of flight data units by applying a local outlier factor algorithm to the mapped flight data units. A method of maintaining an aircraft, a flight data analyzer, a computer program and a computer-readable storage medium is also provided.

The present invention is directed to analyzing flight data to identify anomalous flights and to taking action based on the identification.

Modern commercial aircraft are equipped with flight data recorders (FDR) that collect and record large amounts of data during flights. Parameters such as air speed, altitude, engine temperature and time of data transmissions to air traffic control are recorded. The data is collected from a variety of sources such as sensors in the aircraft and is stored in a medium capable of surviving accidents.

This data is then analysed offline using flight data monitoring (FDM) software. Flight data monitoring plays a key role in the safety management system, particularly in identifying and assessing risks. FDM aims to enhance safety and reduce the likelihood of accidents. Current state of the art software analyses events, such as an occurrence in which a parameter recorded in the flight data exceeds a pre-determined threshold. This is then flagged by the software which leads to further investigation. In the last decade, there has been a shift from a reactive approach to a more proactive approach and all large commercial aircraft operators are required by law to have a Flight Operational Quality Audit (FOQA) or FDM program which regularly, on a daily or weekly basis, downloads the Flight Recorder data from all the aircraft in their fleet. Analysis of this data allows airplane operators to predict and manage issues more generally, ultimately enhancing airplane operations.

Analysis of the large quantities of data obtained and stored during FDM can be difficult. The analysis may therefore use only a small subset of the available data or recorded parameters. The analysis may also rely on predetermined thresholds for parameters to indicate that a problem has occurred on a flight, and may only review such events within a single flight. Performing an analysis in this way relies on predetermined knowledge of what parameter values may lead to an accident or other issue and also is restricted only to circumstances known to result in an accident.

It is an aim of the present invention to improve analysis of flight data.

According to the present invention there is provided a computer implemented method of identifying anomalous flight data, the method comprising: receiving a plurality of flight data units in a time series from each of a plurality of different flights, wherein each flight data unit comprises a value for each of a plurality of flight parameters at the same time point; mapping the flight data units as respective data points to a multi-dimensional space, wherein the dimensions of the multi-dimensional space comprise a dimension for each of the plurality of flight parameters; and identifying one or more anomalous flight data units in the received plurality of flight data units by applying a local outlier factor algorithm to the mapped flight data units.

The above method allows large amounts of flight data to be analyzed simultaneously and efficiently. Anomalies can be identified with high sensitivity and reliability without the need for predetermined thresholds for particular parameters.

The use of the local outlier factor (LOF) algorithm makes it possible to quantify how far a data point is from normal data points rather than merely identifying whether or not a data point belongs to a cluster. The quantitative information may be used to tune a sensitivity of the method for detecting anomalous flight data units, for example to increase sensitivity in situations where false positives can be tolerated or to decrease sensitivity to reduce the number of false positives. The quantitative information may be used to support investigation into why flight data units are anomalous, such as to determine a cause of unusual flight behaviour.

In an arrangement, the LOF algorithm is used to calculate an outlier score for each of the plurality of flight data units. The flight data unit may be identified as anomalous when the outlier score of the flight data unit derived by the LOF algorithm deviates from a normal value by more than a predetermined value. The LOF algorithm may be configured to determine a spatial variation of a local density of the data points in the multi-dimensional space. The outlier score may be calculated for each flight data unit based on a position of the data point corresponding to the flight data unit relative to the determined spatial variation of local density. The degree to which a data point is in a sparse region of the parameter space may be quantified by the outlier score. This may provide quantitative information about how anomalous a flight data unit is. A level of anomaly of a flight may be monitored as a function of time by calculating LOF scores as a function of time. This may make it possible to identify when a flight becomes anomalous without requiring a human expert to analyze a huge data set after a flight as a whole has been identified as anomalous or after an accident has occurred.

In an arrangement, the predetermined value is calculated based on a statistical distribution of the calculated outlier scores. This approach promotes efficient interpretation of the outlier scores by enabling a sensitivity of the method to be adjusted automatically in way that allows appropriate distinction to be made between normal flight data units and truly anomalous flight data units.

In an arrangement, the predetermined value is calculated such that outlier scores higher than a calculated threshold are identified as anomalous, the calculated threshold being equal to the sum of a value of a predetermined percentile of the distribution and a predetermined percentile range multiplied by a predetermined factor. This approach is robust against extreme values in the data because it relies on a percentile and a percentile range that can both be away from the extremes. The predetermined percentile may be a first quartile or a third quartile for example. The predetermined percentile range may be the interquartile range. The predetermined factor may be in range of 1 to 2, optionally substantially equal 1.5.

In an arrangement, the determination of the spatial variation of the local density of the data points is performed based on distances between data points and nearest neighbours of the data points. The distances may be determined using the Manhattan distance. Using the Manhattan distance may reduce the computational load and therefore increase the efficiency of the analysis of large quantities of data.

In some arrangements, the method comprises comprising calculating an average outlier score of at least one of the following phases of at least one of the plurality of flights: take-off, initial climb, cruise, approach, descent or landing, wherein the average outlier score is calculated using the outlier score of each of the flight data units recorded at a time point falling within the said phase, wherein for each phase of the flight, that phase is identified as anomalous when the average outlier score of the said phase deviates from a normal value by more than a predetermined value.

Determining a particular phase of a flight as anomalous in this way may allow a particular phase to be identified as anomalous even when the behaviour of the aircraft at each time step within the phase would not have previously been recognized as anomalous, for example because individual parameter thresholds have not been exceeded. The method may therefore identify anomalous behaviour that would not have previously been recognized, reducing the potential for accidents and increasing the efficiency of aircraft operation.

The method may further comprise the step of calculating an average outlier score of the group of flight data units corresponding to at least one of the plurality of different flights; and the at least one of the plurality of different flights may be identified as anomalous when the average outlier score of said flight deviates from a normal value by more than a predetermined value.

Determining a particular flight as anomalous in this way may allow a particular flight to be identified as anomalous even when the behaviour of the aircraft at each time step within the flight would not have previously been recognized as anomalous. The method may therefore identify anomalous behaviour that would not have previously been recognized, reducing the potential for accidents and increasing the efficiency of aircraft operation.

The local outlier factor algorithm may be applied a plurality of times using a plurality of different values of k. A value of k that achieves higher than average or maximal outlier scores may be selected. The selected value of k may be used to perform the identifying of the one or more anomalous flight data units.

Deriving the k-value to be used for the identification of anomalies in this way may further increase the performance of method. In particular, the literature relating to local outlier factor algorithms suggests merely that k should normally be more than 10. However, a value of k that is above 10 but still relatively small would make the algorithm susceptible to noise while a value of k that is too large will not detect local anomalies. There cannot be one definite value for k in finding the anomalous flights as each dataset will be unique in number of total flights (samples) and number of flight parameters. As a consequence there are no predefined statistical methods to find the most optimal value of k. However, by calculating the outlier scores for many different values of k, for example across an entire fleet, the inventors have found that it is possible to find advantageous or optimal k values.

The method may be performed at a ground location.

Performing the analysis at a ground location may allow the method to be performed more often and therefore increase the speed at which anomalies are identified while avoiding the increased use of computing resources on the aircraft during a flight.

According to an aspect of the present disclosure, there is provided a method of maintaining an aircraft, the method comprising: determining at least one flight parameter as responsible for the identification of one or more flight data units as anomalous according to the method of any embodiment of the present disclosure; and performing a physical operation on the aircraft based on the determined at least one flight parameter.

According to an aspect of the present disclosure, there is provided a flight data analyzer, the flight data analyzer comprising: a receiving unit configured to receive a plurality of flight data units in a time series from each of a plurality of different flights, wherein each flight data unit comprises a value for each of a plurality of flight parameters at the same time point; a mapping unit configured to map the flight data units as respective data points to a multi-dimensional space, wherein the dimensions of the multi-dimensional space comprise a dimension for each of the plurality of flight parameters; and an identification unit configured to identify one or more anomalous flight data units in the received plurality of flight data units by applying a local outlier factor algorithm to the mapping flight data units.

According to an aspect of the present disclosure, there is provided a computer program comprising instructions which, when executed by a computer system, instructs the computer system to perform the method of any embodiment of the present disclosure.

According to an aspect of the present disclosure, there is provided a computer-readable storage medium comprising instructions which, when executed by a computer, cause the computer to carry out the method of any embodiment of the present disclosure.

Embodiments will now be described by way of example only, with reference to the figures in which:

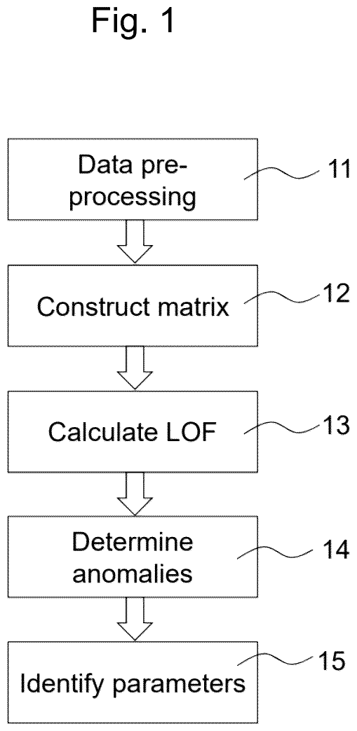

FIG. 1 is a flowchart showing an example of the steps performed to identify anomalous flight data;

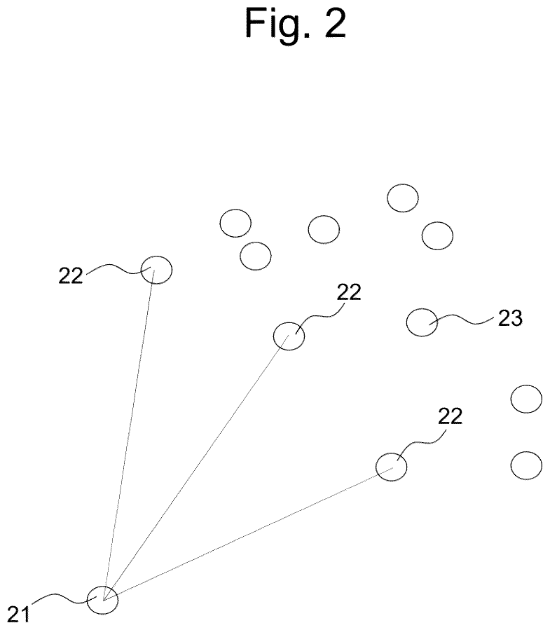

FIG. 2 is a diagram showing an example of local outlier factor analysis;

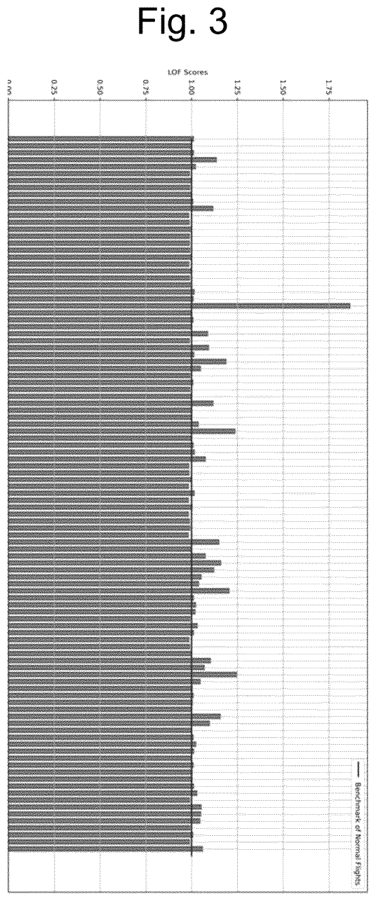

FIG. 3 is a graph showing LOF scores assigned to a plurality of flights;

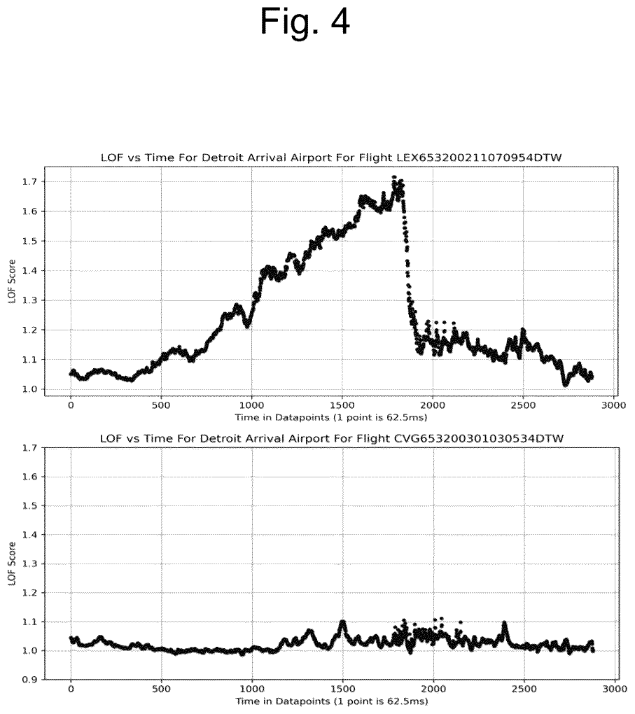

FIG. 4 shows graphs indicating LOF scores of a plurality of flight data units of an anomalous phase of first flight and a non-anomalous phase of a second flight with respect to time;

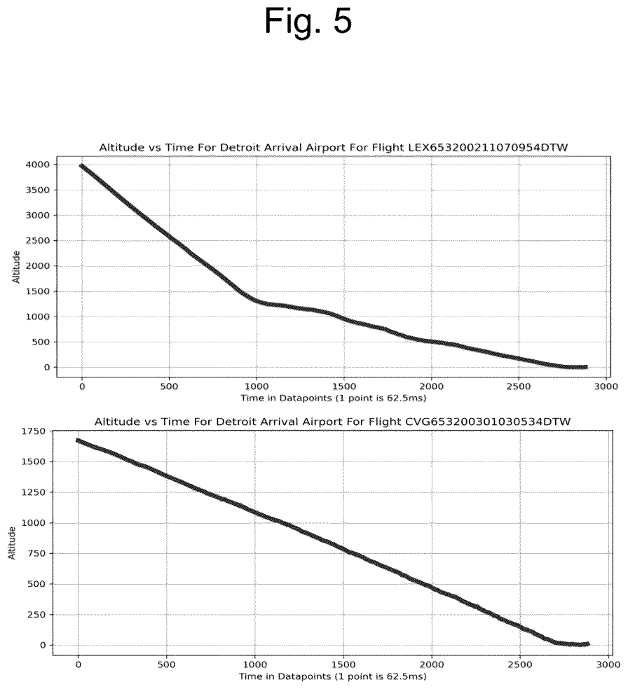

FIG. 5 shows graphs indicating the altitude of the aircraft of the flights shown in FIG. 3 with respect to time;

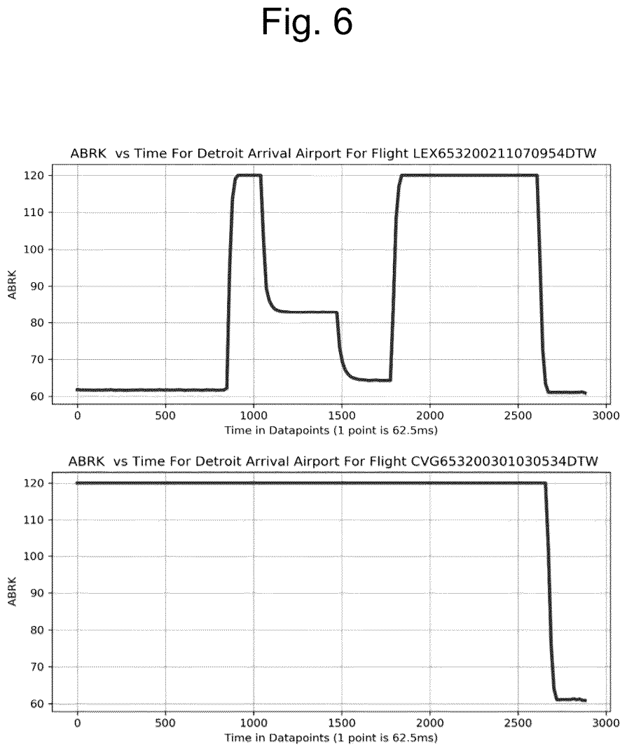

FIG. 6 shows graphs indicating the airbrake position of the aircraft of the flights shown in FIG. 3 with respect to time;

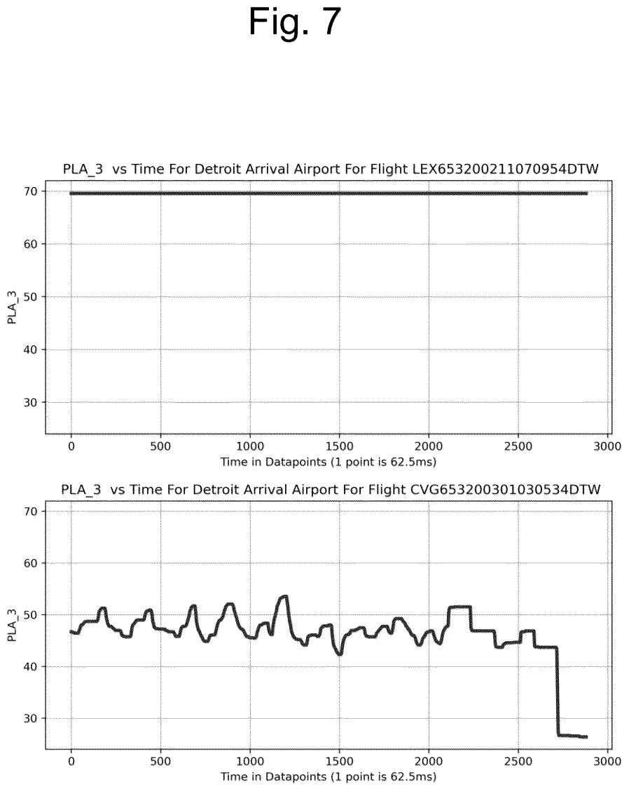

FIG. 7 shows graphs indicating the power lever angle of an engine of the aircraft of the flights shown in FIG. 3 with respect to time;

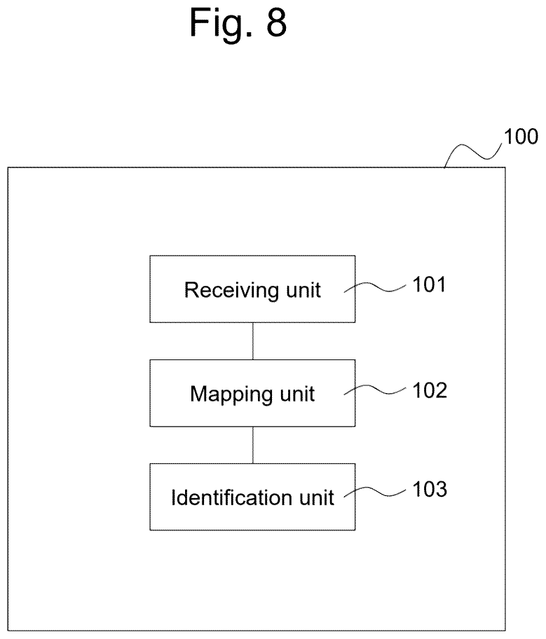

FIG. 8 is an example of a flight data analyzer;

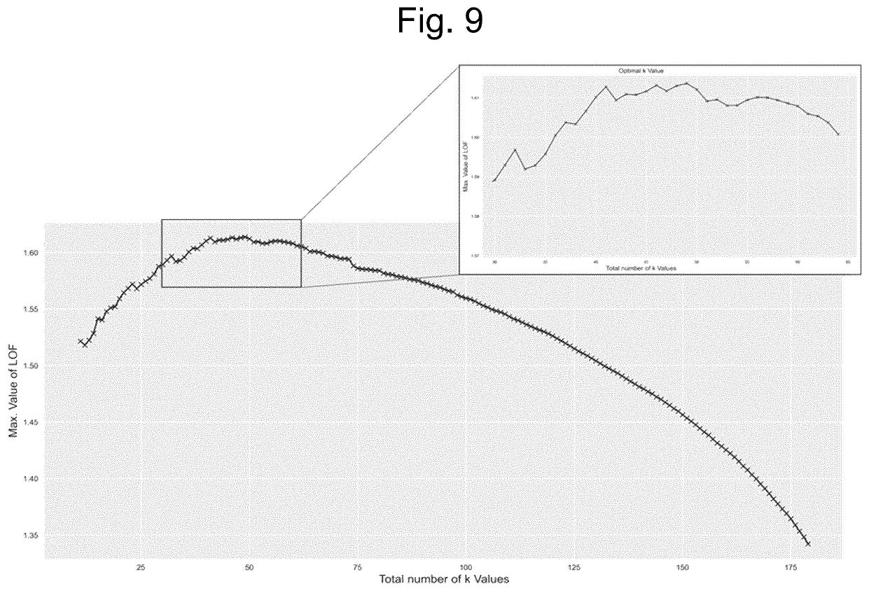

FIG. 9 is a graph showing maximum LOF scores obtained in an example implementation for all considered flights at Minneapolis airport for different values of k;

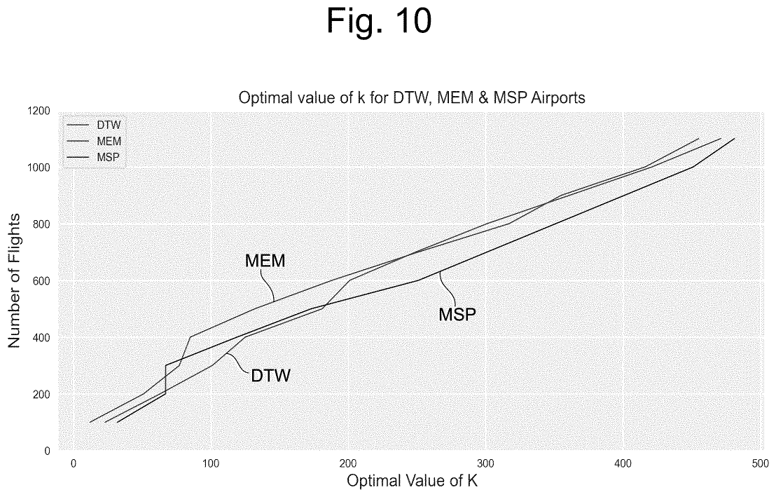

FIG. 10 is a graph depicting optimal value of k plotted against number of flights for three different airports (DTW=Detroit; MEM=Memphis; MSP=Minneapolis);

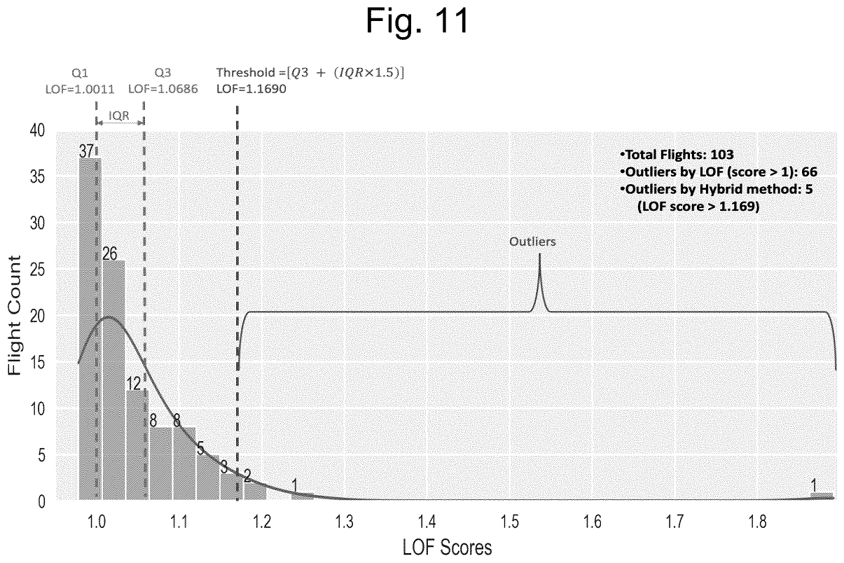

FIG. 11 is a graph illustrating example determination of a LOF threshold using Tukey's method;

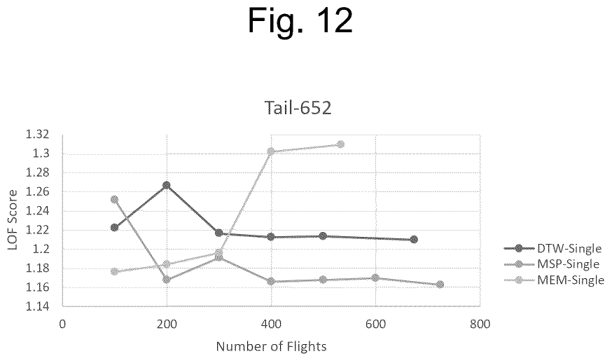

FIG. 12 is graph depicting threshold analyses for three airports;

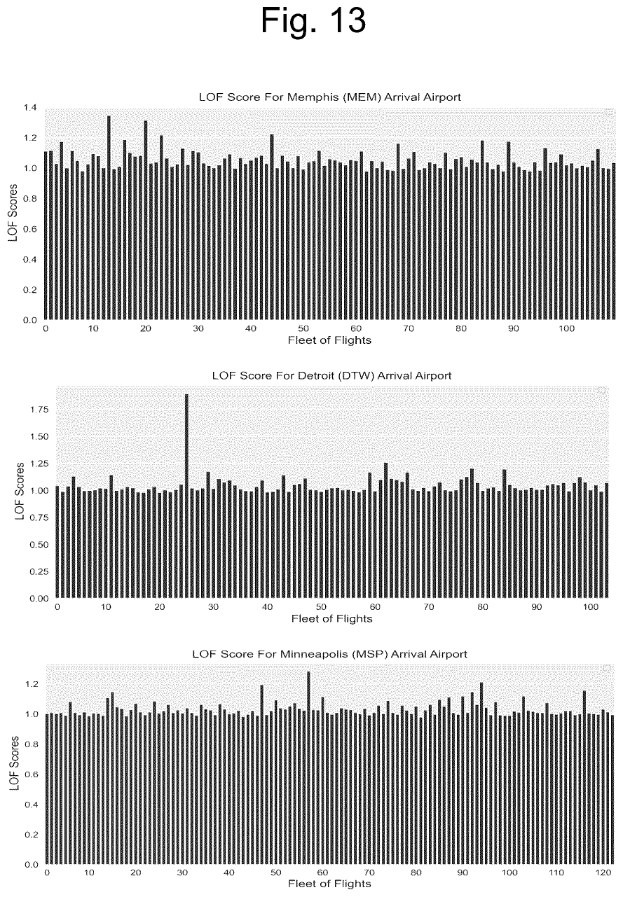

FIG. 13 are graphs showing LOF scores (y-axes) for different fleets of flights (x-axes) for three different airports (top to bottom);

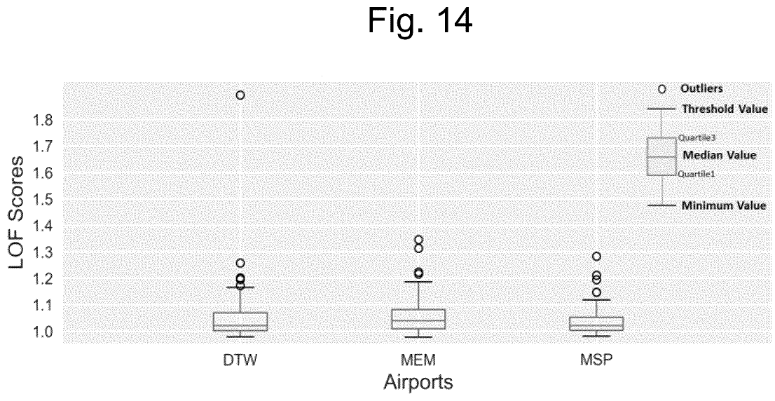

FIG. 14 is a graph showing boxplots for three different airports showing outliers identified using a statistically derived LOF score threshold (deriving using Tukey's method);

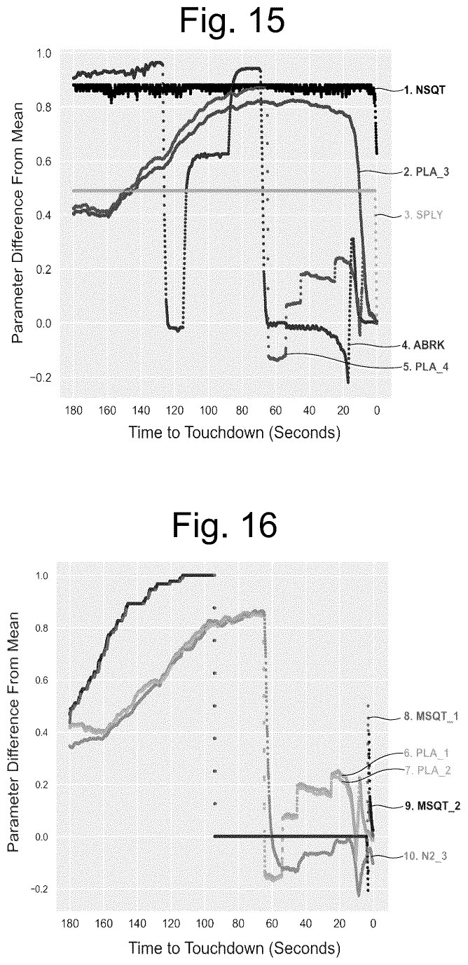

FIGS. 15 and 16 depict variation with flight time of the top 10 flight parameters responsible for an anomalous flight during the last 3 minutes before touchdown; and

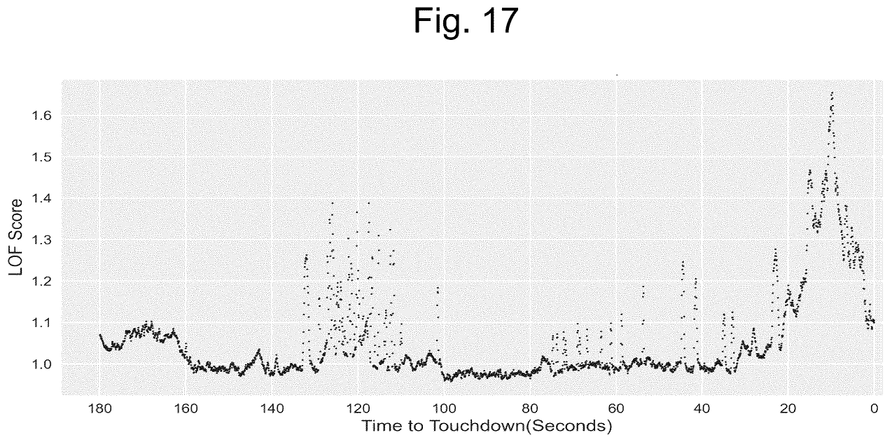

FIG. 17 is a graph showing how a LOF score of a flight changes over time during the last 3 minutes before touchdown.

FIG. 1 shows an example of steps in a method to identify anomalous flight data. The method comprises receiving flight data. In the example shown, the flight data is received in step 11. The flight data may comprise a plurality of flight data units. Each flight data unit may comprise flight data obtained at a single time point in time.

Each flight data unit is associated with a particular point in time during a flight path of a flight performed by the aircraft associated with the flight data unit. A plurality of flight data units may be obtained at a corresponding plurality of different time points during the flight. The plurality of flight data units obtained during the flight therefore comprises time series data.

The time point is recorded together with the flight data in the flight data unit. The time point may be recorded with respect to a reference time point in the flight path of the flight. The reference time point may be associated with a “beginning” of the flight. The first flight data unit of a flight may thus be recorded with a time value of 0. Each subsequent flight data unit associated with that flight may be assigned a time value based on the time that has passed since the first flight data unit was recorded. In some arrangements, the reference time point associated with the beginning of the flight may be defined as one of the following: when an aircraft control system is powered on; when the pilots assume control of the aircraft; when all of the passengers have boarded the aircraft; when the aircraft moves away from the departure gate; when the aircraft begins accelerating down the runaway during take-off; and when the aircraft becomes airborne.

The plurality of flight data units may comprise flight data units corresponding to one or more phases of the flight. The transition from one phase of a flight to another phase of a flight may be defined by a characteristic feature of one of the phases. In an arrangement, a flight parameter reaching a threshold value may be a characteristic feature. For example, the transition from one phase of a flight to another phase of a flight may take place when the flight reaches a threshold value in at least one of altitude, engine power or climb/decent rate. A flight may be divided into at least the take-off, initial climb, cruise, approach, descent and landing phase. Flight data units correspond to a phase of a flight when the time point associated with the flight data unit falls within the phase of the flight. The reference time point may be defined relative to a characteristic feature of one of the phases of the flight. The reference time point may be defined as the beginning or the end of one of the phases of the flight.

In some arrangements, the time series data are recorded with a constant time step. In an alternative arrangement, at least one flight parameter may be recorded at a different rate. In this case, preprocessing of the time series data may be performed to synchronize the sampling rate of each of the flight parameters. The flight data units may be sampled at a constant rate. For example, the flight data units may be sampled at a rate of 16 Hz. In some arrangements, the time series nature of the flight data is maintained throughout the analysis of the data described below. For example, the flight data may processed by the method without combining or averaging the flight data.

The received flight data comprises a plurality of flight data units in a time series from each of a plurality of different flights. The plurality of flight data units may comprise flight data units corresponding to multiple instances of a particular flight path. The multiple instances may comprise repeated flights between two destinations. The repeated flights may be performed by the same aircraft or a plurality of aircraft of the same type. The time series of the flight data units of each of the flights may be synchronized in the preprocessing of the time series data. This means that the time point of each flight data unit is defined relative to a common reference time point in the flight paths of the plurality of flights. The preprocessing may thus comprise synchronizing the flight data units such that flight data units having the same time point from different flights will correspond to the same portion of each flight.

Each flight data unit may comprise values of a plurality of flight parameters. Flight parameters are parameters associated with the aircraft for which the flight data is being recorded. Flight data associated with a flight parameter is recorded as a numerical value of the flight parameter. Examples of flight parameters are parameters related to the position of the aircraft, such as latitude, longitude and altitude. Further examples are parameters related to the orientation of the aircraft, such as pitch and yaw. Further examples are parameters associated with specific components of the aircraft such as the engines, rudder, flaps or landing gear. For example, engine temperature is a flight parameter associated with the engines. When an aircraft has more than one of a component, separate flight data may be recorded for each of the components. For example, engine temperature may be recorded separately for each of the two, three, four or more engines of the aircraft. The table provided at the end of this description includes examples of a number of flight parameters that may be recorded as flight data in flight data units.

During the first step 11, pre-processing may be performed on the flight data. Pre-processing is any processing performed on the flight data before the grouping analysis discussed in more detail below is performed. For example, the flight data may be analysed to determine if any flight data is missing. In an arrangement, missing flight units may be identified based on the absence of flight data associated with particular time steps. In an arrangement, if missing flight data is identified, the flight data recorded by the flight data monitoring system may be checked to determine if the missing flight data was not received due to an error when retrieving the flight data from the FDM system. Pre-processing may include removal of data from the flight data. For example, any data that does not relate to a time step or a flight parameter may be removed from the flight data. Pre-processing may include normalization of the data associated with the flight parameters. However, during the pre-processing step, relative proportions of the values of the flight data associated with each of the flight parameters is maintained. This means that the further steps of the method described below are performed on flight data values that are directly proportional to the flight data values received from the FDM system. For example, the flight data associated with each flight parameter is not averaged over a number of time steps. The flight data associated with each flight parameter is not converted into a different value that is not directly associated with a flight parameter before further analysis is performed.

In a second step 12, the flight data units from each of a plurality of different flights are mapped as respective data units onto a multi-dimensional space. In an arrangement, the flight data units are assembled into a flight data matrix. Each flight parameter corresponds to a column or row of the flight data matrix. The flight data matrix therefore represents a multi-dimensional space where each flight parameter corresponds to a dimension of the multi-dimensional space. In an arrangement, the time point of each flight data unit is also included in the flight data matrix. The multi-dimensional space therefore may further comprise a time dimension that represents the time series of each plurality of flight data units.

In a third step 13, a grouping analysis is performed on the flight data matrix or plurality of flight data matrices. When the grouping analysis is performed on the plurality of flight data matrices, the grouping analysis is performed separately on each flight data matrix. In this arrangement, the grouping analysis compares each of the flight data units with one or more flight data units from other flights recorded at a corresponding time point or time window in those flights. The time point or time window is defined relative to the reference time point in the respective flight path. The time window may include flight data units recorded at adjacent time points to the corresponding time point in the other flights.

An example of a grouping analysis that may be performed is the application of a local outlier factor (LOF) algorithm. The LOF algorithm may, for example, take any of the forms described in Breunig, M., Kriegel, H., Ng, R., & Sander, J. (2000). LOF. Proceedings of The 2000 ACM SIGMOD International Conference On Management Of Data—SIGMOD '00.”

A LOF algorithm is a method which identifies outliers in a dataset that has been mapped to a space and the dataset is therefore represented by points in the space. In arrangements of the present disclosure, the flight data units are mapped to such a space and represented as points (also referred to as data points) in the space. The points in the space may be analysed to determine local densities associated with the points. The LOF algorithm may thus determine a spatial variation of the local density of the data points. An outlier score (which may also be referred to as a LOF score) can be calculated for each flight data unit based on a position of the data point corresponding to the flight data unit relative to the determined spatial variation of local density. The outlier score provides information about the degree to which a data point appears anomalous. The outlier score therefore supports identification of anomalous flight data units. For example, the outlier score may indicate that data points in relatively sparse regions are more likely to be anomalous than data points in denser regions of the space.

The concept of local density is illustrated in FIG. 2. A number of points 21, 22, 23 are mapped to a space. The local density of a point 21 is determined in this example by considering the closest neighbouring points 22 which are defined as the k Nearest Neighbours (kNN) points 22.

The number of closest neighbouring points k that are considered may vary. A value of k (or k-value) of greater than 10 is preferable. When applying a LOF algorithm to flight data as described herein, the LOF algorithm may be applied multiple times using different k-values and a preferable k-value selected for further analysis, as discussed in greater detail below.

Calculating the distance between a point 21 and its kNN points 22 allows the local density in the region of the point 21 to be estimated. More distant points 23 are not considered. The local density of the point 21 is then compared with local densities of the neighbouring points 22. If the point 21 has a lower local density than its neighbours, it may be identified as being an outlier. In FIG. 2, the point 21 has a much lower density than its neighbours 22. Therefore, point 21 is an outlier as compared with its three nearest neighbours.

As mentioned above, the outlier score (e.g., LOF score) may be calculated for each flight data unit based on a position of the data point corresponding to the flight data unit relative to the determined spatial variation of local density. The determination of the spatial variation of the local density may be performed based on the distances between data points and nearest neighbours of the data points. The local density of each data point may be defined using at least a distance between the data point and a k-th nearest neighbour of the data point. In preferred arrangements, each distance is calculated as a Manhattan distance but other approaches (e.g., Euclidean distance) may be used.

In an arrangement, the local density of each data point is defined as a local reachability density according to the following formula:

$$L R {D}_{k} ( A ) = 1 / ( \frac{{\sum }_{B ∈ {N}_{k} ( A )} reach {distance}_{k} ( A , B )}{\vert {N}_{k} ( A ) \vert} )$$

where
LRDₖ(A) is the local reachability density of a data point A for a given value of k;
reach distanceₖ(A, B) is the reachability distance of data point A from data point B, defined as reach distanceₖ(A, B)=max{k-distance(B), d(A, B)}, k-distance(B) being the distance from the data point B to the k-th nearest neighbour of B, and d(A, B) being the distance between data points A and B;
Σ_{B∈N}_{ₖ}_{(A)} reach distanceₖ(A, B) is the sum of the reach distanceₖ(A, B) over all data points B that are equidistant or closer to the data point A than the k-th nearest neighbour of A; and
   |Nₖ(A)| is the number of data points that are equidistant or closer to the data point A than the k-th nearest neighbour of A.

The outlier score for each data point may be calculated by mathematically comparing the local reachability density of the data point with the local reachability density of a group of neighbouring data points.

For example, the outlier score for a data point A for a given value of k, LOFₖ(A), may be given by the following expression:

$${LOF}_{k} ( A ) = \frac{{\sum }_{B ∈ {N}_{k} ( A )} \frac{L R {D}_{k} ( B )}{L R {D}_{k} ( A )}}{\vert {N}_{k} ( A ) \vert} = \frac{{\sum }_{B ∈ {N}_{k} ( A )} L R {D}_{k} ( B )}{\vert {N}_{k} ( A ) \vert * L R {D}_{k} ( A )} .$$

A simplified example of the application of a LOF algorithm is provided below.

In this simplified example, the flight data matrix comprises four flight data units recorded on four flights F1, F2, F3 and F4. Each flight data unit comprises three flight parameters. In this example, the three parameters are altitude, mach speed and flap setting.

In this example, these parameters are represented by x, y and z respectively. In the pre-processing step, the value of each parameter is normalized to be between 0 and 1. The parameter values for each flight at a point t in time are as follows:

| | | | |
|---|---|---|---|
| 1. Flight F1: | x = 0.05437 | y = 0.04587 | z = 0.04879 |
| 2. Flight F2: | x = 0.53982 | y = 0.98243 | z = 0.99654 |
| 3. Flight F3: | x = 0.06345 | y = 0.05784 | z = 0.06002 |
| 4. Flight F4: | x = 0.058946 | y = 0.03789 | z = 0.03989 |

### Step 1: Calculation of Distance Between Points

In this step, the distance between each pair of points (referred to above as d(A, B) for points A and B) in the multidimensional space is determined. In this example, the distance is calculated as the Manhattan distance between each of the pairs of points. The Manhattan distance is calculated as the sum of the absolute values of the differences of the coordinates of the two points for which the distance is being calculated. The Manhattan distance may be preferred for use in the LOF algorithm over a Euclidean distance because the calculation of the Manhattan distance requires only absolute values and does not require the squaring of values or taking of square roots. This reduces the complexity of the algorithm and therefore may be more efficient in terms of calculation time or hardware use. The Manhattan distance for each pair of example flight data units is calculated below.
1. Manhattan Distance (F1, F2)

$$\vert xF 1 - xF 2 \vert + \vert γ F 1 - γ F 2 \vert + \vert zF 1 - zF 2 \vert$$

$$\vert 0.05437 - 0.53 \; 982 \vert + \vert 0.04587 - 0.98 \; 243 \vert + \vert 0.04879 - 0.9 \; 9654 \vert$$

$$( 0.48545 + 0.93656 + 0.94775 ) = 2.36976$$

2. Manhattan Distance (F1, F3)

$$\vert xF 1 - xF 3 \vert + \vert γ F 1 - γ F 3 \vert + \vert zF 1 - zF 3 \vert$$

$$\vert 0.05437 - 0.06 \; 345 \vert + \vert 0.04587 - 0.05 \; 784 \vert + \vert 0.04879 - 0.0 \; 6002 \vert$$

$$( 0.00908 + 0.01197 + 0.01123 ) = 0.03228$$

3. Manhattan Distance (F1, F4)

$$\vert xF 1 - xF 4 \vert + \vert γ F 1 - γ F 4 \vert + \vert zF 1 - zF 4 \vert$$

$$\vert 0.05437 - 0.05 \; 894 \vert + \vert 0.04587 - 0.03 \; 789 \vert + \vert 0.04879 - 0.03 \; 989 \vert$$

$$( 0. 04576 + 0.00798 + 0.0089 ) = 0.0 \; 21456$$

4. Manhattan Distance (F2, F3)

$$\vert xF 2 - xF 3 \vert + \vert γ F 2 - γ F 3 \vert + \vert zF 2 - zF 3 \vert$$

$$\vert 0.53982 - 0.06 \; 345 \vert + \vert 0.98243 - 0.05 \; 784 \vert + \vert 0.99654 - 0.06 \; 002 \vert$$

$$( 0.4 7637 + 0.92459 + 0.93652 ) = 2.33748$$

5. Manhattan Distance (F2, F4)

$$\vert xF 2 - xF 4 \vert + \vert γ F 2 - γ F 4 \vert + \vert zF 2 - zF 4 \vert$$

$$\vert 0.53982 - 0.05 \; 894 \vert + \vert 0.98243 - 0.03 \; 789 \vert + \vert 0.99654 - 0.03 \; 989 \vert$$

$$( 0.4 80874 + 0.94454 + 0.95665 ) = 2.382064$$

6. Manhattan Distance (F3, F4)

$$\vert xF 3 - xF 4 \vert + \vert γ F 3 - γ F 4 \vert + \vert zF 3 - zF 4 \vert$$

$$\vert 0.06345 - 0.058 \; 946 \vert + \vert 0.05784 - 0.03 \; 789 \vert + \vert 0.06002 - 0 \text{.03989} \vert$$

$$( 0. 04504 + 0.01995 + 0.02013 ) = 0.0 \; 44584$$

### Step 2: Finding k^{th} Nearest Neighbor

In this example, a k value of 2 is selected. For each flight data unit a second nearest neighbor is determined based on the calculated Manhattan distance. The second nearest neighbor is the second closest point to each flight data unit. The second nearest neighbour for flight data unit F1 is F3. The second nearest neighbour for flight data unit F2 is F1. The second nearest neighbour for flight data unit F3 is F4. The second nearest neighbour for flight data unit F4 is F3.

Step 3: Manhattan Distance of Each Point from its k^{th} Nearest Neighbor

In this step, the Manhattan distance of each flight data unit to its k^{th}, in this example second, nearest neighbor is selected. This is an example of the k-distance mentioned above with the value of k being 2. The distance of flight data unit F1 from its 2^{nd} nearest neighbour F3 is 0.03228. The distance of flight data unit F2 from its 2^{nd} nearest neighbour F1 is 2.369760. The distance of flight data unit F3 from its 2^{nd} nearest neighbour F4 is 0.044584. The distance of flight data unit F4 from its 2^{nd} nearest neighbour F3 is 0.044584.

### Step 4: k Nearest Neighbor Set of Each Flight

In this step, the set of k nearest neighbors for each flight data unit are determined. The k Nearest Neighbor (k NN) set count (referred to above as |Nₖ(A)| for a point A) for each flight data unit in this example is two. The second nearest neighbor has been determined in the steps above. Therefore, the first nearest neighbor is determined to complete the set. The k Nearest Neighbour set of flight data unit F1 is {F4, F3} as F4 is the nearest neighbour and F3 is the second nearest neighbour. The k Nearest Neighbour set of flight data unit F2 is {F3, F1}. The k Nearest Neighbour set of flight data unit F3 is {F1, F4}. The k Nearest Neighbour set of flight data unit F4 is {F1, F3}.

### Step 5: Local Reachability Density (LRD) Calculation for Each Flight Data Unit

In this step, the local reachability density (LRD) for each point is calculated. The LRD is the estimated distance at which a point is most likely be found from the neighboring points. The LRD is equal to the count of the items in the k NN set of each point over the sum of the reach distance of the point to each of the other points in its k Nearest Neighbor set.

For example, for flight data unit F1:

$$L R D ( F 1 ) = \frac{kNN set count ( F 1 )}{reach distance ( F 4 ← F 1 ) + reach distance ( F 3 ← F 1 )}$$

Where the reach distance in this example is the maximum value of the k^{th} nearest neighbor of the point (second in this example) and the Manhattan distance between the point and its neighbor. For example:

$$reach distance ( F 4 ← F 1 ) = max \{ manhattan distance to KNN of F 4 ,$$

$$manhattan distance between F 1 \& F 4 \}$$

$$reach distance ( F 4 ← F 1 ) = max \{ 0.044584 , 0.0214456 \}$$

$$reach distance ( F 4 ← F 1 ) = 0.044584$$

$$reach distance ( F 3 ← F 1 ) = max \{ manhattan distance to KNN of F 3 ,$$

$$manhattan distance between F 1 \& F 3 \}$$

$$reach distance ( F 3 ← F 1 ) = max \{ 0.044584 , 0. 03228 \}$$

$$reach distance ( F 3 ← F 1 ) = 0.044584$$

Therefore,

$$L R D ( F 1 ) = \frac{2}{0.044584 + 0.044584} = 22.4 \; 29571$$

In the similar manner above, LRD (F2) can be calculated:

$$L R D ( F 2 ) = \frac{2}{2.33748 + 2.36976} = 0.4248774$$

And LRD (F3) and LRD (F4) can both be calculated as 26.01998.

### Step 6: Local Outlier Factor (LOF) Score Calculation for Each Flight Data Unit

In this step, the LOF score (outlier score) of each flight data unit is calculated. The LOF score of a point may be expressed as the sum of the LRD of all the points in the set kNN of that point multiplied with the sum of the reach distance of all the points of the same set to the point, divided by the number of items in the kNN set count squared.

The LOF score for each of the flight data units is calculated as below:

$$1. LOF ( F 1 ) = \frac{\begin{matrix}( LRD ( F 4 ) + L R D ( F 3 ) ) \times \\ ( reach dist . ( F 4 ← F 1 ) + reach dist . ( F 3 ← F 1 ) )\end{matrix}}{{2}^{2}} = \frac{( 26.01998 + 26.01998 ) \times ( 0.0 \; 44584 + 0.0 \; 44584 )}{4} = 1.1 6007$$

$$2. LOF ( F 2 ) = \frac{\begin{matrix}( LRD ( F 3 ) + L R D ( F 1 ) ) \times \\ ( reach dist . ( F 3 ← F 2 ) + reach dist . ( F 1 ← F 2 ) )\end{matrix}}{{2}^{2}} = \frac{( 26.01998 + 22.429571 ) \times ( 2.3 \; 3748 + 2. 36976 )}{4} = 57. 0 \; 15916$$

$$3. LOF ( F 3 ) = \frac{\begin{matrix}( LRD ( F 1 ) + L R D ( F 4 ) ) \times \\ ( reach dist . ( F 1 ← F 3 ) + reach dist . ( F 4 ← F 3 ) )\end{matrix}}{{2}^{2}} = \frac{( 22.42957 + 26.01998 ) \times ( 0.03228 + 0.044584 )}{4} = 0.9 31006$$

$$4. LOF ( F 4 ) = \frac{\begin{matrix}( LRD ( F 4 ) + L R D ( F 3 ) ) \times \\ ( reach dist . ( F 4 ← F 1 ) + reach dist . ( F 3 ← F 1 ) )\end{matrix}}{{2}^{2}} \frac{( 22.429571 + 26.01998 ) \times ( 0.0 \; 3228 + 0. 0 \; 44584 )}{4} = 0.9 31006$$

Applying a LOF algorithm therefore assigns a LOF score to (i.e., calculates a LOF score for) each flight data unit. The LOF score is an example of an outlier score that may be derived for each of the plurality of flight data units.

As discussed above, the LOF algorithm may be applied multiple times using a plurality of different values of k (k-values). In this case, the LOF algorithm is applied for each of the plurality of k-values and a LOF score is assigned to each flight data unit for each k-value. For example, the LOF algorithm may be applied using all k-values in a range from 10 to 180. The method may then select a value of k that achieves higher than average or maximal LOF scores and use the selected value of k to perform the identifying of the one or more anomalous flight data units. For example, where there is a set of LOF scores corresponding to each k-value used, the set of LOF scores containing the maximum LOF score of all of the sets of LOF scores may be determined and used to select the value of k. An example of this approach is described below with reference to FIG. 9. The set of LOF scores corresponding to the selected k-value may be used to identify anomalous flight data units as described below. Applying the LOF algorithm multiple times for different k-values in this way, to obtain an improved or optimal k-value, may increase the sensitivity of the subsequent identification of anomalies (using the selected optimal or improved k-value), for example by reducing the number of false positive identifications.

In a fourth step 14, one or more anomalous flight data units are identified. Anomalous flight data units may be identified using the outlier score (LOF score) assigned to each flight data unit during the grouping analysis. Thus, one or more anomalous flight data units may be identified by applying the LOF algorithm to the mapped flight data units. A flight data unit may be identified as anomalous when the outlier score of said flight data unit deviates from a normal value by more than a predetermined value. The predetermined value may be a percentage of the normal value. For example, the predetermined value may be 10% or 20% of the normal value. When the grouping analysis performed is a LOF algorithm, the LOF score may be interpreted as follows. A LOF score approximately equal to one means that the local density of the point is comparable to its neighbours and thus the point is not anomalous. A LOF score of less than one means that the point has higher local density than its neighbours and thus the point is not anomalous. A LOF score greater than one by more than a predetermined value means that the point has lower local density than its neighbours by an amount significant enough for the point to be considered as anomalous. In an arrangement, the predetermined value may be 0.1 or 0.2.

In the example calculation above, it can be concluded that the flight data unit F2 is anomalous as the calculated LOF score is much greater than 1.2. The other flight data units may be classified as non-anomalous because the calculated LOF score of said flight data units is less than 1.2.

In some arrangements, the predetermined value is calculated based on a statistical distribution of the calculated outlier scores. For example, the predetermined value may be calculated such that outlier scores higher than a calculated threshold are identified as anomalous, with the calculated threshold being equal to the sum of 1) a value of a predetermined percentile of the distribution and 2) a predetermined percentile range multiplied by a predetermined factor. The predetermined percentile may be a first quartile (25^{th} percentile) or a third quartile (75^{th} percentile). The predetermined percentile range may be the interquartile range. The predetermined factor may be in the range of 1 to 2, optionally in the range of 1.2 to 1.8, optionally in the range of 1.4 to 1.6, optionally substantially equal to 1.5. Thus, in one arrangement, the calculated threshold is such that outlier scores that are more than 1.5 times the interquartile range above the third quartile are considered to correspond to anomalous flight data units. This approach makes it possible to generate an appropriate threshold for distinguishing between anomalous and non-anomalous data points in the group of data points having outlier scores that are greater than the normal value (e.g., 1) without requiring detailed manual user input. This is important because the most appropriate threshold to use may vary significantly between different sets of flight data units under consideration. For example, an optimal threshold for a set of flight data units for one type of aircraft, phase of a flight, or particular airport may be significantly different than an optimal threshold for a set of flight data units for a different type of aircraft, phase of flight, or airport. Thus, the calculated threshold may be calculated based on a statistical distribution over the calculated outlier scores of a subset of the data points, the subset of data points corresponding to a predetermined category, such as a predetermined type of aircraft, a predetermined phase of flight, or involvement of a predetermined airport. Furthermore, the optimum threshold to use may vary as a function of the size of the data set that is available (e.g., the number of relevant flight data units that have been received). The methodology may thus comprise receiving further flight data units, calculating new outlier scores corresponding to those flight data units, and updating the calculated threshold to take account of the new outlier scores. The above approach allows an appropriate threshold to be selected and/or updated quickly and reliably, with minimal user input. A particular example of the above approach for calculating a threshold is described in further detail below with reference particularly to FIGS. 11 and 12.

Additional information may be used in the determination of flight data units as anomalous or non-anomalous. For example, the model of the aircraft for which the flight data was recorded may be used. The value of the outlier score or the threshold value used to determine if a flight data unit is anomalous may change depending on the additional information. For example, flight data units comprising flight data recorded on a particular aircraft model may require a higher threshold value to be classified as anomalous.

In an arrangement, particular phases of the flight may be identified as anomalous. The average outlier score of all of the flight data units falling within at least one phase or set time window of a flight may be determined. The average may be any of the mean, median or modal value of the outlier scores assigned to the flight data units. The phase may be identified as anomalous when the average outlier score of the phase deviates from a normal value by more than a predetermined value as discussed above. In an arrangement, a flight may be identified as anomalous. The average outlier score of all of the flight data units falling within flight may be determined. The flight may be identified as anomalous when the average outlier score of the phase deviates from a normal value by more than a predetermined value as discussed above. phase deviates from a normal value by more than a predetermined value as discussed above.

In a fifth step 15, further analysis may be performed to determine at least one of the flight parameters as responsible for the identification of one or more flight data units as anomalous. The grouping method used to determine if particular flight data units are anomalous may not identify which flight parameters of the flight data unit are responsible for the determination. For example, the LOF algorithm described above assigns an LOF score to each flight data unit and a flight data unit may be identified as anomalous based on the LOF score. However, the LOF score does not indicate which flight parameters are responsible for the identification. Therefore, further analysis of the one or more flight data units identified as anomalous is necessary to determine the flight parameters are responsible for the identification. Deviation of a single flight parameter from a normal value may be responsible for the one or more flight data units being identified as anomalous. In an arrangement, deviation of a plurality of flight parameters from normal values may be responsible. An advantage of the method described herein is that anomalous behaviour due to deviation of a plurality of flight parameters may be identified as responsible for flight data units being identified as anomalous even if the deviation of the values of the individual flight parameters does not meet known thresholds of anomalous behaviour.

The further analysis may be performed by manual inspection of the anomalous flight data units. Alternatively or additionally, machine learning techniques may be applied to the anomalous flight data units to identify flight parameters responsible for the anomalous behaviour. Flight parameters may be identified by comparing the flight data associated with the flight parameters in the flight data units identified as anomalous with flight data in flight data units identified as non-anomalous recorded at the same time point in a different flight. A variation in the value of the flight data for the flight parameter in the anomalous flight data unit may indicate that flight parameter as responsible.

FIG. 3 shows the results of the method described herein performed on a plurality of flights where an average outlier score for each flight has been obtained. In this example, the flight data units were recorded in the approach phase of the plurality of flights. In the graph of FIG. 3, each flight is represented on the x-axis and the y-axis indicates the average outlier score of each flight. The majority of the approach phases of the flights have an average outlier score of less than or equal to 1.1. These approaches may therefore be determined as non-anomalous. A number of the approach phases of the flights have an average outlier score of greater than 1.1. These phases may therefore be determined as anomalous.

Once a phase has been determined as anomalous, further analysis may be performed as discussed above. FIG. 4 shows the calculated LOF score for each flight data unit recorded in the approach phase of two flights. The top graph of FIG. 4 shows the calculated LOF score for each data unit recorded in one of the anomalous phases identified in FIG. 3. The bottom graph of FIG. 4 shows the calculated LOF score for each data unit recorded in one of the non-anomalous phases identified in FIG. 3. The trend for the anomalous phase shows that the value of the LOF score initially is non-anomalous. The value of the LOF score then beings to increase around at around the 500th flight data unit of the phase. The value of the LOF score then increases until around the 700th flight data unit of the phase. The value of the LOF score then decreases sharply before dropping to a score that is non-anomalous. In comparison, the calculated LOF score for the non-anomalous phase remains non-anomalous for almost all of the phase. This pattern in the anomalous phase suggests an anomaly developed for which corrective action was taken.

FIGS. 5 to 7 shows the recorded values of a number of flight parameters for the flight phases shown in FIG. 4. The top graph in each figure shows the flight parameter value recorded in the anomalous phase. The bottom graph in each figure shows the flight parameter value recorded in the non-anomalous phase.

FIG. 5 shows the altitude recorded in each phase. In comparison to the non-anomalous phase, in the anomalous phase the altitude is initially higher and decreases more steeply, before adopting a profile more similar to the non-anomalous phase after the 1000th flight data unit. This suggests the pilot began the approach at too high an altitude. FIG. 6 shows the airbrake position recorded in each phase. A lower values indicates higher use of the airbrakes. The high use of airbrakes is shown at the beginning of the anomalous phase, but also after the 1000th flight data unit. This indicates a problem that may not be evident only from the recorded altitude because the high use continues after the altitude has been corrected. FIG. 7 shows the power lever angle for engine 3 recorded in each phase. The constant value of the lever angle in the anomalous phase indicates a potential issue with engine 3, which could be responsible for the other anomalous behaviour of the system. Engine 3 on the aircraft that performed the flight including the anomalous phase could therefore investigated in further detail to identify and fix any malfunctions which may be causing the anomalous behaviour.

An output may be provided representing the identified one or more anomalous flight data units. In an arrangement, the output is output data comprising data identifying the one or more of the flight data units, phases of a flight, flights and flight parameters identified as anomalous. In an arrangement, the output is an alert indicating the one or more of the flight data units, phases of a flight, flights and flight parameters identified as anomalous by the method described herein.

In an arrangement, if the flight data units identified as anomalous are associated with a particular aircraft, that aircraft may be removed from service until the cause of the anomalous identification has been determined. This means that the aircraft will not make any further flights until the cause of the anomalous identification has been determined. Taking this action may reduce the chance of accidents occurring.

In an arrangement, a physical operation may be performed on the aircraft in response to flight data units associated with the aircraft being identified as anomalous. The physical operation may comprise one or more of performing maintenance on the aircraft, performing a repair on a component of the aircraft or replacing a component of the aircraft. The maintenance performed on the aircraft may be a standard inspection or servicing of the aircraft. In this case, the anomalous identification may result in the inspection or servicing being performed earlier than would be expected for the normal service routine of the aircraft. In an arrangement, the physical operation on the aircraft may be performed based on the flight parameter determined as responsible for the identification of one or more flight data units as anomalous. For example, the physical operation may be maintenance to a system of the aircraft relating to the flight parameter that is identified as responsible for the identification of particular flight data units as anomalous. For example, if the identified flight parameter is associated with the engines of the aircraft, engine maintenance may be performed to identify and fix any malfunctions in the engines that may be responsible for the anomalous behaviour.

In an arrangement, training for a pilot may be performed in response to flight data units associated with a flights performed by that pilot being identified as anomalous. The training may be based on the flight parameters identified as responsible for the identification of particular flight data units as anomalous. For example, if the descent angle of an approach performed by the pilot is determined to have been too steep, training on performing an appropriate approach may be provided to the pilot.

In an arrangement, the procedure associated with particular departure or arrival destinations may be modified in response to flight data units associated with the particular destination being identified as anomalous. For example, the procedure for take-off and/or landing for a particular airport may be modified.

After a change has been made in response to the identification of anomalous flight data units, the aircraft, pilot, departure or arrival destination or other common factor may be monitored and the method described above may be performed again to determine if the cause of the anomalous identification has been addressed.

The method described above may be performed by a flight data analyzer 100. An example of a flight data analyzer 100 is shown in FIG. 8. The flight data analyzer 100 comprises a receiving unit 101 configured to receive a plurality of flight data units as described above, a mapping unit 102 configured to map the time series data of the flight data units to a multi-dimensional space, wherein each dimension of the multi-dimensional space corresponds to one of the plurality of flight parameters, and an identification unit 103 configured to use a grouping analysis performed on the mapped time series data as described above to identify one or more anomalous flight data units in the received plurality of flight data units. In an arrangement, the flight data analyzer 100 may further comprise a display. The flight data analyzer 100 may be configured to provide the output data or alert discussed above to a user via the display.

The flight data analyzer 100 may be located at a ground location, such as an airport or data processing center. To perform the analysis, flight data may be retrieved from the FDM system of one or more aircraft at regular intervals. For example, flight data may be retrieved at the end of each flight performed by an aircraft or when the aircraft is at a particular airport or hub. The analysis may be performed at regular intervals. In an arrangement, the analysis may be performed once a threshold number of flight data units have been received. In an arrangement, the analysis may be performed when flight data units associated with a threshold number of any one of aircraft, aircraft models, flight paths, or particular departure or arrival destinations has been reached.

A computer program may comprise instructions which, when executed by a computer system, instructs the computer system to perform the method described above. Such a computer program may be executed by the flight data analyzer 100. A computer-readable storage medium comprising instructions which, when executed by a computer, cause the computer to carry out the method described above. The flight data analyzer 100 may comprise such a computer-readable storage medium.

Examples of flight parameters that may be used in the methods described above are provided in the table below.

| Parameter Name | Description |
|---|---|
| ABRK | Air BRaKe Position in Degrees. |
| AIL_1 | AILeron Number 1 deflection angle in Degrees. |
| | Left (Port) Wing aileron surface. |
| AIL_2 | AILeron Number 2 deflection angle in Degrees. |
| | Right (Starboard) Wing aileron surface |
| ALT | Pressure ALTitude measured in Feet. Aircraft |
| | flight altitude calibrated as per the pressure |
| | setting on the altimeter. |
| ALTR | ALTitude Rate measured in Feet/Minute. The |
| | rate of change in altitude. This indicates at what |
| | rate the aircraft is climbing or descending. |
| AOA1 | Angle of Attack sensor number 1. The angle of |
| | attack is the angle between the aircraft |
| | longitudinal axis and the aircraft flight path. |
| AOA2 | Angle of Attack sensor number 2. The angle of |
| | attack is the angle between the aircraft |
| | longitudinal axis and the aircraft flight path. |
| AOAC | Corrected Angle of Attack measured in Degrees. |
| AOAI | Indicated Angle of Attack measured in Degrees. |
| | This is the angle of attack indicated to the pilot |
| | after correcting for errors between AOA1 and |
| | AOA2. |
| BAL1 | Barometrically Corrected ALtitude 1. Altitude |
| | indicated to the pilot seated on the left based on |
| | QNH or QNE (some Airlines may also opt to use |
| | QFE) |
| BAL2 | Barometrically Corrected ALtitude 2. Altitude |
| | indicated to the pilot seated on the right based |
| | on QNH or QNE (some Airlines may also opt to |
| | use QFE) |
| BLAC | Body Longitudinal ACceleration measured in g |
| CAS | Computed AirSpeed measured in Knots. The |
| | airspeed indicated to the pilots on their airspeed |
| | indicator instruments |
| CASS | Selected Computed AirSpeed. Pilot selected |
| | speed, when flying with speed in CAS, for the |
| | Auto Pilot |
| CTAC | Cross Track ACceleration measured in g |
| DA | Drift Angle measured in Degrees (DEG). This is |
| | equal to the Wind Correction Angle. It is the |
| | difference between the Magnetic/True Heading |
| | (MH/TH) and the Magnetic/True Track |
| | (TRKM/TRK). To fly the required track the aircraft |
| | corrects for wind drift by applying the Drift Angle |
| | to the Heading. This results in the heading to be |
| | flown to maintain the required track. |
| EGT_1 | Engine Number 1 Exhaust Gas Temperature. |
| | Very high EGT may indicate a problem. |
| EGT_2 | Engine Number 2 Exhaust Gas Temperature. |
| | Very high EGT may indicate a problem. |
| EGT_3 | Engine Number 3 Exhaust Gas Temperature. |
| | Very high EGT may indicate a problem. |
| EGT_4 | Engine Number 4 Exhaust Gas Temperature. |
| | Very high EGT may indicate a problem. |
| ELEV_1 | ELEVator Number 1 deflection angle in Degrees. |
| | Left (Port) Tailplane elevator surface. |
| ELEV_2 | ELEVator Number 2 deflection angle in Degrees. |
| | Right (Starboard) Tailplane elevator surface. |
| FF_1 | Engine Number 1 Fuel Flow in Pounds per Hour |
| | (LBS/HR). |
| FF_2 | Engine Number 2 Fuel Flow in Pounds per Hour |
| | (LBS/HR). |
| FF_3 | Engine Number 3 Fuel Flow in Pounds per Hour |
| | (LBS/HR). |
| FF_4 | Engine Number 4 Fuel Flow in Pounds per Hour |
| | (LBS/HR). |
| FLAP | Trailing Edge FLAP Position measured in counts. |
| | The BAE146/AVRO RJ Series has five flap |
| | positions 0°, 18°, 24°, 30° and 33º degrees. |
| FPAC | Flight Path ACceleration measured in g. This is |
| | the acceleration measured along the aircraft's |
| | flight path. Similar to BLAC but not projected out |
| | of the longitudinal axis of the aircraft but out of |
| | the actual aircraft flight path. |
| FQTY_1 | Fuel QuantiTY TANK 1 Left (Port) wing measured |
| | in Pounds (LBS). |
| FQTY_2 | Fuel QuantiTY TANK 2 Right (Starboard) wing |
| | measured in Pounds (LBS). |
| FQTY_3 | Fuel QuantiTY TANK 3 Centre Pannier Tanks (if |
| | installed) measured in Pounds (LBS). |
| FQTY_4 | Fuel QuantiTY TANK 4 Centre Pannier Tanks (if |
| | installed) measured in Pounds (LBS). |
| GLS | GLide Slope Deviation. It indicates the aircraft's |
| | vertical path relative to an ILS Glideslope. |
| GS | Ground Speed in Knots. This is the actual speed |
| | of the aircraft over the Earth's surface after |
| | considering all external factors. |
| IVV | Inertial Vertical (Velocity) Speed in Feet/Minute. |
| | Similar to ALTR however the measurement is |
| | being performed by the Inertial Reference |
| | System (IRS) (Also known as INS - Inertial |
| | Navigation System). |
| LATG | LATeral acceleration measured in g. The lateral |
| | axis is an imaginary line passing through the |
| | centre of the aircraft from port (left) to |
| | starboard (right) (normally from wing tip to wing |
| | tip). Accelerations about this axis affect the |
| | longitudinal stability (Pitch) of the aircraft. Pitch |
| | is controlled by the Elevators however as for |
| | LONG above external forces may also induce |
| | pitch |
| LGDN | Landing Gear DowN Locked. |
| LONG | LONGitudinal acceleration measured in g. The |
| | longitudinal axis is an imaginary line passing |
| | from the nose to the tail of the aircraft. |
| | Accelerations about this axis affect the lateral |
| | stability (Roll) of the aircraft. Roll is controlled by |
| | the Ailerons however roll may also be induced by |
| | external forces. |
| MACH | MACH Number measured as a ratio of the Speed |
| | of Sound the measure is simply referred to as |
| | Mach. The airspeed in Mach Number as |
| | indicated to the pilots on their airspeed indicator |
| | instruments. |
| MH | Magnetic Heading measured in Degrees (DEG). |
| | This is where the aircraft's nose is pointing |
| | relative to Magnetic North. |
| MSQT_1 | SQuaT switch left (1) Main gear. It indicates if |
| | aircraft weight is on the left main gear wheel. |
| | Used to indicate how the aircraft took off or |
| | landed. |
| MSQT_2 | SQuaT switch right (2) Main gear. It indicates if |
| | aircraft weight is on the right main gear wheel. |
| | Used to indicate how the aircraft took off or |
| | landed. |
| N1_1 | Engine Number 1 Fan (N1) speed in % RPM. Very |
| | low or 0% RPM during flight indicates a seized |
| | engine. |
| N1_2 | Engine Number 2 Fan (N1) speed in % RPM. Very |
| | low or 0% RPM during flight indicates a seized |
| | engine. |
| N1_3 | Engine Number 3 Fan (N1) speed in % RPM. Very |
| | low or 0% RPM during flight indicates a seized |
| | engine. |
| N1_4 | Engine Number 4 Fan (N1) speed in % RPM. Very |
| | low or 0% RPM during flight indicates a seized |
| | engine. |
| N1C | N1 Command. Autothrottle commands an N1 |
| | RPM for all engines based on the autothrottle |
| | mode to maintain the required thrust. |
| N1T | Selected Engine N1 Target RPM. Pilot selected |
| | engine N1 Target (applies to all engines) to be |
| | maintained by the autothrottle system. |
| N2_1 | Engine Number 1 Core (N2) speed in % RPM. |
| | Very low or 0% RPM during flight indicates a |
| | seized engine. |
| N2_2 | Engine Number 2 Core (N2) speed in % RPM. |
| | Very low or 0% RPM during flight indicates a |
| | seized engine. |
| N2_3 | Engine Number 3 Core (N2) speed in % RPM. |
| | Very low or 0% RPM during flight indicates a |
| | seized engine. |
| N2_4 | Engine Number 4 Core (N2) speed in % RPM. |
| | Very low or 0% RPM during flight indicates a |
| | seized engine. |
| OIP_1 | Engine Number 1 OIl Pressure. Measured in |
| | Pounds per Square Inch (PSI). Low oil pressure or |
| | excessively high oil pressure during flight may |
| | indicate an engine problem. |
| OIP_2 | Engine Number 2 OIl Pressure. Measured in |
| | Pounds per Square Inch (PSI). Low oil pressure or |
| | excessively high oil pressure during flight may |
| | indicate an engine problem. |
| OIP_3 | Engine Number 3 OIl Pressure. Measured in |
| | Pounds per Square Inch (PSI). Low oil pressure or |
| | excessively high oil pressure during flight may |
| | indicate an engine problem. |
| OIP_4 | Engine Number 4 OIl Pressure. Measured in |
| | Pounds per Square Inch (PSI). Low oil pressure or |
| | excessively high oil pressure during flight may |
| | indicate an engine problem. |
| OIT_1 | Engine Number 1 OIl Temperature. Measured in |
| | Degrees (DEG) Celsius. |
| OIT_2 | Engine Number 2 OIl Temperature. Measured in |
| | Degrees (DEG) Celsius. |
| OIT_3 | Engine Number 3 OIl Temperature. Measured in |
| | Degrees (DEG) Celsius. |
| OIT_4 | Engine Number 4 OIl Temperature. Measured in |
| | Degrees (DEG) Celsius. |
| PLA_1 | Power Lever Angle for engine number 1 |
| PLA_2 | Power Lever Angle for engine number 2 |
| PLA_3 | Power Lever Angle for engine number 3 |
| PLA_4 | Power Lever Angle for engine number 4 |
| PTCH | PITCH angle measured in Degrees. The Angle |
| | between the Horizon and the aircraft |
| | longitudinal axis. |
| PTRM | Pitch TRiM Position. Measured in Degrees. |
| RALT | Radio ALTitude measured in Feet. This is a very |
| | sensitive instrument which is activated when in |
| | close proximity to the Earth's surface, typically |
| | within 5000 Feet. This instrument gives very |
| | accurate height above terrain information during |
| | Take-Off and Landing. |
| ROLL | Aircraft ROLL Angle in Degrees. The roll angle |
| | caused by the displacement of the ailerons |
| | and/or external environmental factors. |
| RUDD | RUDDer deflection angle in Degrees. 0 degrees is |
| | the centre position and −ve and +ve values |
| | determine the deflection left or right. |
| RUDP | RUDder Pedal Position. Indicates yaw inputs |
| | measured in counts. |
| SPL 1 | Roll SPoiLer 1 deflection angle in Degrees. Left |
| | (Port) Wing spoiler surface. |
| SPL_2 | Roll SPoiLer 1 deflection angle in Degrees. Right |
| | (Starboard) Wing spoiler surface. |
| TAS | True AirSpeed measured in Knots. Actual aircraft |
| | speed through the air. |
| TH | True Heading measured in Degrees (DEG). This is |
| | where the aircraft’s nose is pointing relative to |
| | True North. |
| TRK | TRacK Angle True measured in Degrees (DEG). |
| | This is the aircraft’s track over the Earth's surface |
| | relative to True North. |
| TRKM | TRack Angle Magnetic measured in Degrees |
| | (DEG). This is the aircraft’s track over the Earth's |
| | surface relative to Magnetic North. |
| VRTG | VeRTical acceleration measured in g. The vertical |
| | axis is an imaginary line passing through the |
| | centre of the aircraft (usually situated between |
| | the wings) from the top to the bottom of the |
| | aircraft. Accelerations about this axis affect the |
| | directional stability (Yaw) of the aircraft. Yaw is |
| | controlled by the Rudder however as for LONG |
| | above external forces may also induce yaw. |

The flow charts and descriptions thereof herein should not be understood to prescribe a fixed order of performing the method steps described therein. Rather, the method steps may be performed in any order that is practicable. Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

Methods and processes described herein can be embodied as code (e.g., software code) and/or data. Such code and data can be stored on one or more computer-readable media, which may include any device or medium that can store code and/or data for use by a computer system. When a computer system reads and executes the code and/or data stored on a computer-readable medium, the computer system performs the methods and processes embodied as data structures and code stored within the computer-readable storage medium. In certain embodiments, one or more of the steps of the methods and processes described herein can be performed by a processor (e.g., a processor of a computer system or data storage system).

It should be appreciated by those skilled in the art that computer-readable media include removable and non-removable structures/devices that can be used for storage of information, such as computer-readable instructions, data structures, program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that is capable of storing computer-readable information/data. Computer-readable media should not be construed or interpreted to include any propagating signals.

### DETAILED EXAMPLE

Further details of an example implementation are given below.

Accidents during the approach and landing phase accounts for more than 50% of all the accidents, even though this phase is only 16% of the flight time. For the present example, the approach and landing phase were selected for study. In this phase, only three minutes before touchdown were studied to detect anomalous flights. The touchdown point for each aircraft was identified using Phase (PH), Weight on Wheels (WOW), Latitude (LAT) and Longitude (LONG) flight parameters. To avoid negative values of flight parameter Altitude (ALT) for a given airport, the minimum altitude value for that airport was subtracted from all readings of ALT flight parameter. In this way all the flight landings at a given airport were synchronized in time with each other to touch down at same time.

The data set was cleaned of any noise or missing data by the onboard sensor. All flight parameters were normalized to accommodate different units and range of values of flight parameters. The data files were converted from MAT files to SQL tables for better access and analysis. Flight parameters were recorded at sampling rate ranging from 1 Hertz to 16 Hertz. Parameters sampled at lower rates were converted to 16 Hertz by interpolating the values. This was done to match the total number of data points for all the parameters for synchronization purposes.

In the LOF algorithm, parameter k is the neighborhood size which defines the neighborhood of a data point for the computation of its local density. In principle, the value of k should be lower bounded by the minimum number of points in a cluster while the upper bound should be the maximum number of nearest points that can potentially be anomalies. However, such information is generally not available and highly domain dependent. Even if such information is available, the optimal k value between the lower bound and upper bound is still undefined. A range of k values is suggested as one value of k cannot be generalized over various datasets with diverse underlying data distribution. Aviation data is a time series based multidimensional data. The dimensions typically run into thousands. Data being of higher dimensions, heterogeneously unstructured and having diverse underlying distributions makes the process of determining optimal value of k more challenging.

A small value of k is not preferred as the algorithm becomes sensitive to noise and a too large value will not detect local anomalies. There cannot be one definite value for k in finding the anomalous flights as each dataset given will be unique in number of total flights (samples) and number of flight parameters. As such there are no pre-defined statistical methods to find the most optimal value of k. In the present example, before implementing LOF algorithm the optimal k value was determined by calculating the LOF score values for each possible k value. Selecting k above 10 should help to remove unwanted statistical fluctuations. In the aviation domain it is typically difficult to fix a lower bound for k as we do not know how many minimum similar objects a cluster will have (other objects can be outliers relative to this cluster), or we do not know the exact number of normal flights. Similarly, we also cannot decide the total number of anomalous flights in each dataset and hence the upper bound for k cannot be fixed. Since the algorithm in this example uses unsupervised learning, we do not have labelled data or know in advance the normal or abnormal flights; as a consequence, k can take a wide range of possible numbers. For every k value we see the LOF score calculated. The k value which gives the highest LOF score may be selected as the optimal k value. The k value corresponding to the highest LOF score is chosen to catch the instance at which the object is the most outlying. The lowest LOF score is not chosen as it will erase the outlying nature of an object completely.

Distance measure is another important parameter of the LOF algorithm. Choosing the right type of distance measure is important. Euclidean distance was not chosen as the distance measure because as the dimensionality increases, the curse of dimensionality impacts Euclidean distance measure. In case of flight data there are 132 parameters recorded at different time steps. The dimensions run into thousands. Cosine similarity as the distance measure is suitable for high dimensional datasets. But the disadvantage with this measure is that it ignores the magnitude of vectors and only considers their direction. Therefore, the difference in values may not be considered which are important to detect anomalous flights.

The Manhattan distance was chosen to find the optimal value of k as it calculates the distance between real valued vectors. This helps to capture the k value where a data point is most outlying. More importantly flight data has both discrete and binary attributes. For instance, flight parameters like landing gear, weight on wheels has only values as 0 or 1. Using Manhattan as the distance measure helps in this scenario as it considers the paths that realistically could be taken within values of such attributes. Manhattan distance measure is fast as compared to Euclidean distance as for each pair of distance calculation, there is no need for squaring or taking square roots to get absolute values.

As an example, Minneapolis airport is taken. There are in total 200 flights in a dataset arriving at this airport. We calculate LOF score for all possible k values between 10 and 180. The k value which gives the highest LOF score will the optimal one. In this case k value of 41 is the most optimal as it has the highest LOF score of 1.62. The left side of the FIG. 9 gives the plot for the LOF score and possible k values between 10 and 180. From the plot it can be seen that the highest LOF value is in between k value of 25 & 55. Also, in between this range only k value stabilises before decreasing. The highest LOF score is between k values 40 and 45. The highlighted box of the FIG. 9 highlights that the highest LOF score is at k value of 41. Therefore 41 is the optimal k value for this case.

For the purpose of comparison, FIG. 10 shows the line plot comparing the optimal k values for three airports Detroit, Minneapolis and Memphis. The optimal k value is for different total number of flights arriving at each airport. It has been suggested previously that a suitable setting of k value should satisfy k=√N, for the datasets with a sample size N which is larger than 100. However, such a setting has been found to be unsuitable for flight data under this study. In case of detection of anomalous flights, this general rule is not valid due to the nature of aviation data. As discussed above, better performance is achieved by allowing dynamic variation in the value of k, dependent for example on total number of fights and the arrival airport.

Based on the optimal k value identified and Manhattan as the distance measure, LOF score for each flight with the same tail number approaching same airport is calculated. As a rule of thumb, any flight with LOF score greater than one may be considered anomalous. All such flights may need to be investigated further. Investigating all flights satisfying this criterion is a laborious process and requires a lot of human effort. Setting up a threshold can help to further filter the flight data units and/or flights which have score greater than one but are still normal. The following explains in detail an example approach for selecting the threshold.

As discussed above, any data point ‘A’ deep inside a cluster (dense region) having density comparable to its neighbors or higher than its neighbors will be an inlier. The LOF score of such point A will be =1 or <1. Points with LOF value>1 may be labelled as outliers. Such points may be near the periphery of the cluster or dense region (LOF value slightly greater than 1) or far outside the cluster (LOF value significantly greater than 1). In practice, how far a point should be from a cluster of points (dense region) to be truly considered an outlier (i.e., truly anomalous) may vary from application to application. It is therefore desirable to provide a method for calculating a threshold above which a point can be categorized as anomalous. This threshold will define how far a point should be from a cluster of points (dense region) to be categorized as an outlier.

Defining this threshold is to an extent dependent on the field of application. For instance, in life sciences even points with LOF values close to 1 are of interest for further investigations. In this field it is acceptable to have more false positives, whereas false negatives may not be tolerated. While discussing results with aviation experts, the inventors came across many flights having LOF values greater than 1 but which in practice fit under the standard operating procedures and pose no threat to safety. So, to decrease false positives, a method for fine tuning the LOF threshold value was desired. The upper limit of LOF value greater than 1 but which could still safely be a normal flight was to be determined as a threshold. Deciding this threshold with feedback from human expert is not only a laborious process but also introduces human bias. It was also found that this threshold will change for each group of flights and for each arrival airport. To decide this threshold, statistical methods such as the z score method, Bell curve method, Tukey's method and median method were explored.

Tukey's test was chosen for the present example as it is distribution independent. Tukey's (1977) method, constructing a boxplot, is a simple graphical tool to display information about continuous univariate data, such as the median, lower quartile, upper quartile, lower extreme, and upper extreme of a data set. It is less sensitive to extreme values of the data because it uses quartiles which are resistant to extreme values. The rules of the method are as follows:

The IQR (Inter Quartile Range) is the distance between the lower (Q1) and upper (Q3) quartiles.

Inner fences are located at a distance 1.5 IQR below Q1 and above Q3 as given by:

[Q1−(1.5*IQR),Q3+(1.5*IQR)]

Outer fences are located at a distance 3 IQR below Q1 and above Q3 as given by:

[Q1−(3*IQR),Q3+(3*IQR)]

A value between the inner and outer fences is a possible outlier. An extreme value beyond the outer fences is a probable outlier. For the detection of anomalous flights inner fences are considered.

FIG. 11 shows group of 103 flights from the same tail number arriving at the same airport. On x-axis LOF scores are plotted and on y-axis flight count is plotted. Out of 103 flights, 66 flights have their LOF score greater than 1. Analyzing all these 66 flights is very time consuming. As per Tukey's rule of inner fence mentioned above, the threshold comes to LOF value of 1.1690. There are now only five flights which are greater than this threshold. These are the real outliers. FIG. 12 shows the threshold analysis of three different arrival airports. For each airport flights from the same tail number were taken and then after calculating LOF scores, threshold was fixed as explained above. For each case a threshold of LOF score was established as per Tukey's rule. FIG. 12 shows that for each airport, threshold is dynamic and stabilizes after certain value.

Having established the threshold for our flight data, the following section shows how additional information may be inferred.

In this step, further plots were plotted to get more insight into the flights. These plots included LOF scores and flight parameters at each time stamp during the flight. Furthermore, flight parameters responsible for the anomalous behaviour were identified and plotted. To find parameters responsible for the anomalous behaviour of any anomalous flight, the mean of all flight parameters for all normal flights were calculated. Then for each flight parameter of the anomalous flight the value of each flight parameter was subtracted from the mean value of that parameter of all normal flights. This was done to get the flight parameter that was furthest away from the mean value of the same flight parameter of normal flights. In this way top n flight parameters which may be responsible for the anomalous behaviour can be found which are further away from the mean values of those n parameters of normal flights. These plots are discussed in detail in the following section.

A set of flights with the same tail number was analyzed for three different airports and the LOF score of each set is plotted in FIG. 13. From FIG. 13 the LOF score of each flight in the set can be seen for three different airports and highly abnormal flights can be seen from the bar chart. FIG. 14 combines the LOF algorithm and the Tukey's method for threshold calculation. It shows how for each of the three different airports the LOF threshold is different and dynamic. This plot also shows the median LOF values for each airport and the anomalous flights as outliers for each airport. Detroit (DTW) airport is taken as a case study. From FIG. 11 and FIG. 14 we can see that DTW has five flights as outlier. One flight with the LOF score of 1.86 is an extreme outlier.

Plots of parameter difference from a mean can be created for a top N flight parameters responsible for the anomalous behaviour. In such plots, the flight duration can be plotted on the x-axis and on the y-axis abnormal flight parameters can be plotted in the order of how far they were from normal flight parameters. Examples of such plots are shown in FIGS. 15 and 16 for the present example, with the top 5 flight parameters (1-5) shown in FIG. 15 and the next 5 flight parameters (6-10) shown in FIG. 16. Such plots support investigation into what might have caused a flight to be abnormal. From discussions with the human expert, it was concluded that this flight may have been highly anomalous due to flight parameter ABRK (Air Brakes). Frequent use of air brakes to slow down the aircraft just before touch down may have caused this anomalous behaviour. Similar analyses were done for the remaining four anomalous flights and many flight parameters like engine vibrations, high speed, and pitch were found to be some of the contribution factors behind the anomalous behaviour.

FIG. 17 shows changing LOF value at each time stamp during the last three minutes of the landing phase. This figure shows how the LOF values change in time as the flight is about to touchdown. The figure shows that the flight became anomalous just 20 seconds before the touchdown. This plot for any flight can be used to find the time window when this flight was anomalous and to what extent was flight anomalous. We found that many flights were anomalous during approach and landing phase, but these flights became normal while touching down. So, any normal flights can also be investigated to check for any instance where these flights might have become anomalous.

These results were verified and validated by the industry expert. Flights labelled anomalous for each airport were also anomalous as per the human expert. Tukey's method reduced the number of false positives; however there were still some false positives which were labelled anomalous but from aviation point of view were normal. For example, a change in the route to approach might be a normal procedure on a busy day of air traffic but such change was detected as an anomalous behaviour by the proposed method.

Further aspects of the disclosure are defined in the following numbered clauses.

1. A computer implemented method of identifying anomalous flight data, the method comprising: receiving a plurality of flight data units in a time series from each of a plurality of different flights, wherein each flight data unit comprises a value for each of a plurality of flight parameters at the same time point; mapping the flight data units to a multi-dimensional space, wherein the dimensions of the multi-dimensional space comprise a dimension for each of the plurality of flight parameters; using a grouping analysis performed on the mapped flight data units to identify one or more anomalous flight data units in the received plurality of flight data units.
2. The method of clause 1, wherein the dimensions of the multi-dimensional space further comprise a time dimension to represent the time series of each plurality of flight data units.
3. The method of clause 2, wherein the time dimension is defined relative to a common reference time point in the flight paths of the plurality of flights.
4. The method of any preceding numbered clause, wherein the grouping analysis comprises comparing each of one or more of the flight data units with flight data units from other flights recorded at a corresponding time point or time window in those flights, the time point or time window being defined relative to a reference time point in the respective flight path.
5. The method of clause 3 or 4, wherein the reference time point comprises a reference point defined relative to a characteristic feature of one of the following phases of the flight: take-off, initial climb, cruise, approach, descent and landing.
6. The method of any preceding numbered clause, wherein the grouping analysis is performed using a local outlier factor algorithm.
7. The method of any preceding numbered clause, wherein the grouping analysis comprises determining the k-nearest neighbors of each of the mapped flight data units.
8. The method of clause 7, wherein the distance from each mapped flight data unit to each neighbor in the multi-dimensional space is determined using a Manhattan distance to determine the k-nearest neighbors.
9. The method of any preceding numbered clause, wherein the grouping analysis derives an outlier score for each of the plurality of flight data units; and for each of the plurality of flight data units, that flight data unit is identified as anomalous when the outlier score of said flight data unit deviates from a normal value by more than a predetermined value.
10. The method of clause 9, wherein: the method further comprises the step of calculating an average outlier score of at least one of the following phases of at least one of the plurality of flights: take-off, initial climb, cruise, approach, descent or landing, wherein the average outlier score is calculated using the outlier score of each of the flight data units recorded at a time point falling within the said phase; and for each phase of the flight, that phase is identified as anomalous when the average outlier score of the said phase deviates from a normal value by more than a predetermined value.
11. The method of clause 9 or 10, wherein: the method further comprises the step of calculating an average outlier score of the group of flight data units corresponding to at least one of the plurality of different flights; and the at least one of the plurality of different flights is identified as anomalous when the average outlier score of said flight deviates from a normal value by more than a predetermined value.
12. The method of any one of clauses 9 to 11, wherein: the grouping analysis is performed a plurality of times using a plurality of different k-values when determining the k-nearest neighbors; and the grouping analysis that derives the highest maximum outlier score of the grouping analyses using the plurality of different k-values is used to identify the one or more anomalous flight data units in the received plurality of flight data units.
13. The method of any preceding numbered clause, further comprising the step of: performing further analysis to determine at least one of the flight parameters as responsible for the identification of one or more flight data units as anomalous.
14. The method of any preceding numbered clause, wherein the method is performed at a ground location.
15. The method of any preceding numbered clause, further comprising providing an output representing the identified one or more anomalous flight data units.
16. A method of maintaining an aircraft, the method comprising: determining at least one flight parameter as responsible for the identification of one or more flight data units as anomalous according to the method of clause 13; and performing a physical operation on the aircraft based on the determined at least one flight parameter.
17. A flight data analyzer, the flight data analyzer comprising: a receiving unit configured to receive a plurality of flight data units in a time series from each of a plurality of different flights, wherein each flight data unit comprises a value for each of a plurality of flight parameters at the same time point; a mapping unit configured to map the flight data units to a multi-dimensional space, wherein the dimensions of the multi-dimensional space comprise a dimension for each of the plurality of flight parameters; an identification unit configured to use a grouping analysis performed on the mapped flight data units to identify one or more anomalous flight data units in the received plurality of flight data units.
18. A computer program comprising instructions which, when executed by a computer system, instructs the computer system to perform the method of any one of clauses 1 to 15.
19. A computer-readable storage medium comprising instructions which, when executed by a computer, cause the computer to carry out the method of any one of clauses 1 to 15.

1. A computer implemented method of identifying anomalous flight data, the method comprising:
receiving a plurality of flight data units in a time series from each of a plurality of different flights, wherein each flight data unit comprises a value for each of a plurality of flight parameters at the same time point;
mapping the flight data units as respective data points to a multi-dimensional space, wherein the dimensions of the multi-dimensional space comprise a dimension for each of the plurality of flight parameters; and
identifying one or more anomalous flight data units in the received plurality of flight data units by applying a local outlier factor algorithm to the mapped flight data units.

2. The method of claim 1, wherein the dimensions of the multi-dimensional space further comprise a time dimension to represent the time series of each plurality of flight data units.

3. The method of claim 2, wherein the time dimension is defined relative to a common reference time point in the flight paths of the plurality of flights.

4. The method of claim 1, wherein the local outlier factor algorithm comprises comparing each of one or more of the flight data units with flight data units from other flights recorded at a corresponding time point or time window in those flights, the time point or time window being defined relative to a reference time point in the respective flight path.

5. The method of claim 3, wherein the reference time point comprises a reference point defined relative to a characteristic feature of one of the following phases of the flight: take-off, initial climb, cruise, approach, descent and landing.

6. The method of claim 1, comprising preprocessing the received plurality of flight data units prior to the mapping the flight data units to the multi-dimensional space, the preprocessing comprising synchronizing the flight data units such that flight data units having the same time point from different flights will correspond to the same portion of each flight.

7. The method of claim 1, wherein the local outlier factor algorithm is used to calculate an outlier score for each of the plurality of flight data units.

8. The method of claim 7, wherein a flight data unit is identified as anomalous when the outlier score of the flight data unit derived by the local outlier factor algorithm deviates from a normal value by more than a predetermined value.

9. The method of claim 8, wherein:
the local outlier factor algorithm is configured to determine a spatial variation of a local density of the data points in the multi-dimensional space; and
the outlier score is calculated for each flight data unit based on a position of the data point corresponding to the flight data unit relative to the determined spatial variation of local density.

10. The method of claim 9, wherein the predetermined value is calculated based on a statistical distribution of the calculated outlier scores.

11. The method of claim 10, wherein the predetermined value is calculated such that outlier scores higher than a calculated threshold are identified as anomalous, the calculated threshold being equal to the sum of
a value of a predetermined percentile of the distribution; and
a predetermined percentile range multiplied by a predetermined factor.

12. The method of claim 11, wherein the predetermined percentile is a first quartile or a third quartile.

13. The method of claim 11, wherein the predetermined percentile range is the interquartile range.

14. The method of claim 11, wherein the predetermined factor is in the range of 1 to 2, optionally substantially equal to 1.5.

15. The method of claim 11, wherein the calculated threshold is calculated based on a statistical distribution over the calculated outlier scores of a subset of the data points, the subset of data points corresponding to a predetermined category, such as a predetermined type of aircraft, a predetermined phase of flight, or involvement of a predetermined airport.

16. The method of claim 11, comprising receiving further flight data units, calculating new outlier scores corresponding to those flight data units, and updating the calculated threshold to take account of the new outlier scores.

17. The method of claim 9, wherein the determination of the spatial variation of the local density of the data points is performed based on distances between data points and nearest neighbours of the data points.

18. The method of claim 17, wherein the local density of each data point is defined using a distance between the data point and a k-th nearest neighbour of the data point, where k is an integer.

19. The method of claim 18, wherein the distances are determined using the Manhattan distance.

20. The method of claim 18, wherein the local density of each data point is defined as a local reachability density according to the following formula:
$$LR {D}_{k} ( A ) = 1 / ( \frac{{\sum }_{B ∈ {N}_{k} ( A )} reach {distance}_{k} ( A , B )}{\vert {N}_{k} ( A ) \vert} )$$
where
LRDₖ(A) is the local reachability density of a data point A for a given value of k;
reach distanceₖ(A, B) is the reachability distance of data point A from data point B, defined as reach distanceₖ(A, B)=max{k-distance(B), d(A, B)}, k-distance(B) being the distance from the data point B to the k-th nearest neighbour of B, and d(A, B) being the distance between data points A and B;
Σ_{B∈N}_{ₖ}_{(A)} reach distanceₖ(A, B) is the sum of the reach distanceₖ(A, B) over all data points B that are equidistant or closer to the data point A than the k-th nearest neighbour of A; and

|Nₖ(A)| is the number of data points that are equidistant or closer to the data point A than the k-th nearest neighbour of A.

21. The method of claim 20, wherein the outlier score for each data point is calculated by mathematically comparing the local reachability density of the data point with the local reachability density of a group of neighbouring data points.

22. The method of claim 20, wherein the outlier score for a data point A for a given value of k, LOFₖ(A), is given by the following expression:
$${LOF}_{k} ( A ) = \frac{{\sum }_{B ∈ {N}_{k} ( A )} \frac{L R {D}_{k} ( B )}{L R {D}_{k} ( A )}}{\vert {N}_{k} ( A ) \vert} = \frac{{\sum }_{B ∈ {N}_{k} ( A )} L R {D}_{k} ( B )}{\vert {N}_{k} ( A ) \vert * L R {D}_{k} ( A )} .$$

23. The method of claim 18, wherein:
the local outlier factor algorithm is applied a plurality of times using a plurality of different values of k;
the method comprises selecting a value of k that achieves higher than average or maximal outlier scores; and
the method comprises using the selected value of k to perform the identifying of the one or more anomalous flight data units.

24. The method of claim 7, comprising calculating an average outlier score of at least one of the following phases of at least one of the plurality of flights: take-off, initial climb, cruise, approach, descent or landing, wherein the average outlier score is calculated using the outlier score of each of the flight data units recorded at a time point falling within the said phase, wherein for each phase of the flight, that phase is identified as anomalous when the average outlier score of the said phase deviates from a normal value by more than a predetermined value.

25. The method of claim 7, comprising calculating an average outlier score of the group of flight data units corresponding to at least one of the plurality of different flights, wherein the at least one of the plurality of different flights is identified as anomalous when the average outlier score of said flight deviates from a normal value by more than a predetermined value.

26. The method of claim 1, wherein for at least one of the different flights the outlier score is determined for each of a plurality of different flight data units in a time series of flight data units received for that flight.

27. The method of claim 1, wherein the method is performed at a ground location.

28. The method of claim 1, further comprising providing an output representing the identified one or more anomalous flight data units.

29. The method of claim 1, comprising performing further analysis to determine at least one of the flight parameters as responsible for the identification of one or more flight data units as anomalous.

30. A method of maintaining an aircraft, the method comprising:
determining at least one flight parameter as responsible for the identification of one or more flight data units as anomalous according to the method of claim 29; and
performing a physical operation on the aircraft based on the determined at least one flight parameter.

31. A flight data analyzer, the flight data analyzer comprising:
a receiving unit configured to receive a plurality of flight data units in a time series from each of a plurality of different flights, wherein each flight data unit comprises a value for each of a plurality of flight parameters at the same time point;
a mapping unit configured to map the flight data units as respective data points to a multi-dimensional space, wherein the dimensions of the multi-dimensional space comprise a dimension for each of the plurality of flight parameters; and
an identification unit configured to identify one or more anomalous flight data units in the received plurality of flight data units by applying a local outlier factor algorithm to the mapping flight data units.

32. (canceled)

33. A non-transitory computer-readable storage medium comprising instructions which, when executed by a computer, cause the computer to carry out the method of claim 1.
